(19) United States
(12) Patent Application Publication
(10) Pub. No.: US 2026/0017723 A1
(43) Pub. Date: Jan. 15, 2026

(54) Home Scores Determined from Claims Data

(71) Applicant: STATE FARM MUTUAL AUTOMOBILE INSURANCE COMPANY, Bloomington, IL (US)

(72) Inventors: Jason Goldfarb, Bloomington, IL (US); Richa Shrestha, Plano, TX (US); Sean Hickey, Albuquerque, NM (US); Bryan Nussbaum, Edwardsville, IL (US); Laura A. Uphoff, Normal, IL (US)

(21) Appl. No.: 19/027,173

(22) Filed: Jan. 17, 2025

Related U.S. Application Data
(60) Provisional application No. 63/669,531, filed on Jul. 10, 2024.
(60) Provisional application No. 63/696,460, filed on Sep. 19, 2024.

(51) Int. Cl. G06Q 40/08

(52) U.S. Cl. CPC G06Q 40/08

(57) ABSTRACT

The following relates generally to generating and/or modifying home scores based upon insurance claim data. In some embodiments, one or more processors: generate an overall home score for a subject property; receive insurance claim data for an insurance claim corresponding to the subject property, wherein the insurance claim data includes (i) a monetary amount of the insurance claim, and/or (ii) a category of the insurance claim; modify the overall home score based upon the insurance claim data; and/or display the overall home score.

### CROSS REFERENCE TO RELATED APPLICATIONS

This application claims the benefit of: (i) U.S. Provisional Application No. 63/696,460, entitled “Home Scores Determined from Claims Data” (filed Sep. 19, 2024), and (ii) U.S. Provisional Application No. 63/669,531, entitled “Home Scores Determined from Claims Data” (filed Jul. 10, 2024), the entirety of each of which is incorporated by reference herein.

### FIELD

The present disclosure generally relates to determining a home score, and, more particularly, relates to determining a home score based upon insurance claim data.

### BACKGROUND

Determining and presenting a home score (e.g., a score rating a home, etc.) may be important to an insurance company. For example, when an insurance customer's home has a high home score, the insurance company may offer the customer a discount on homeowners insurance. However, present systems for determining and/or displaying home scores and/or subscores may have certain drawbacks.

The systems and methods disclosed herein may provide solutions to these problems and may provide solutions to the ineffectiveness, insecurities, difficulties, inefficiencies, encumbrances, and/or other drawbacks of conventional techniques.

### SUMMARY

The present embodiments may relate to, inter alia, determining a home score based upon insurance claim data. For example, a home score and/or subscores may first be calculated, such as via a machine learning (ML) or non-ML technique. Subsequently, the home score and/or subscores may be modified based upon insurance claim data. Advantageously, modifying the home score and/or subscores may improve the accuracy of the home score and/or subscores.

In one aspect, a computer-implemented method for improved determination and display of a home score based upon insurance claim data may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) generating, via one or more processors, an overall home score for a subject property; (2) receiving, via the one or more processors, insurance claim data for an insurance claim corresponding to the subject property, wherein the insurance claim data includes (i) a monetary amount of the insurance claim, and/or (ii) a category of the insurance claim; (3) modifying, via the one or more processors, the overall home score based upon the insurance claim data; and/or (4) displaying, via the one or more processors, the overall home score. The method may include additional, fewer, or alternate actions, including those discussed elsewhere herein.

In another aspect, a computer device configured for improved determination and display of a home score based upon insurance claim data may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) generate an overall home score for a subject property; (2) receive insurance claim data for an insurance claim corresponding to the subject property, wherein the insurance claim data includes (i) a monetary amount of the insurance claim, and/or (ii) a category of the insurance claim; (3) modify the overall home score based upon the insurance claim data; and/or (4) display the overall home score. The computer device may include additional, less, or alternate functionality, including that discussed elsewhere herein.

In yet another aspect, a computer system configured for improved determination and display of a home score based upon insurance claim data may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) generate an overall home score for a subject property; (2) receive insurance claim data for an insurance claim corresponding to the subject property, wherein the insurance claim data includes (i) a monetary amount of the insurance claim, and/or (ii) a category of the insurance claim; (3) modify the overall home score based upon the insurance claim data; and/or (4) display the overall home score. The computer system may include additional, less, or alternate functionality, including that discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1A depicts an exemplary home score system, according to one embodiment.

FIG. 1B depicts an exemplary screen of an exemplary user device.

FIG. 1C depicts an exemplary screen displaying an overall home score and subscores.

FIG. 1D depicts an exemplary screen displaying an overall home score and subscores including an appliances subscore rather than a heating, ventilation, and air conditioning (HVAC) subscore.

FIG. 2 illustrates a flow diagram representing an exemplary computer-implemented method or implementation for generating a home score based upon insurance claim data.

FIG. 3 shows an exemplary table indicating information of an exemplary fire protection attribute.

FIG. 4 is a block diagram of an exemplary machine learning modeling method for training and evaluating a ML algorithm, in accordance with various embodiments.

FIG. 5 depicts a flow diagram representing an exemplary computer-implemented method or implementation for improved determination and display of a home score based upon insurance claim data.

FIG. 6 depicts an exemplary screen allowing a user to indicate completion of one or more insights.

FIG. 7 depicts an exemplary method of modifying the home score based upon a geographic area of the subject property and/or a seasonal category.

### DETAILED DESCRIPTION

The present embodiments relate to, inter alia, generating and/or comparing home scores. Advantageously, an insurance company may provide an insurance customer with a discount on, for example, homeowners insurance or renters insurance based upon a high home score.

In some examples, an overall home score is generated based upon one or more subscores, such as (i) a safety subscore, (ii) a structural subscore, (iii) a plumbing subscore, (iv) an appliances subscore, and/or (v) a heating, ventilation, and air conditioning (HVAC) subscore. In some implementations, there is no HVAC subscore. In some such implementations, the appliances subscore includes an HVAC grade (rather than the system including a separate HVAC subscore).

Further advantageously, the overall home score or any of the subscores may be improved by being modifying by insurance claim data. For example, an initial home score for a subject property may be generated, and then modified by insurance claims data. In one working example, a human expert (e.g., a plumber, etc.) grades a home to generate an initial plumbing subscore for the home. Subsequently, insurance claims data received indicates that there has not been any water damage insurance claims for the subject property in the last five years; and, in response, the system increases the plumbing subscore. Advantageously, modifying the home score based upon insurance claims data improves accuracy of the system (e.g., produces a more accurate home score).

### Exemplary System

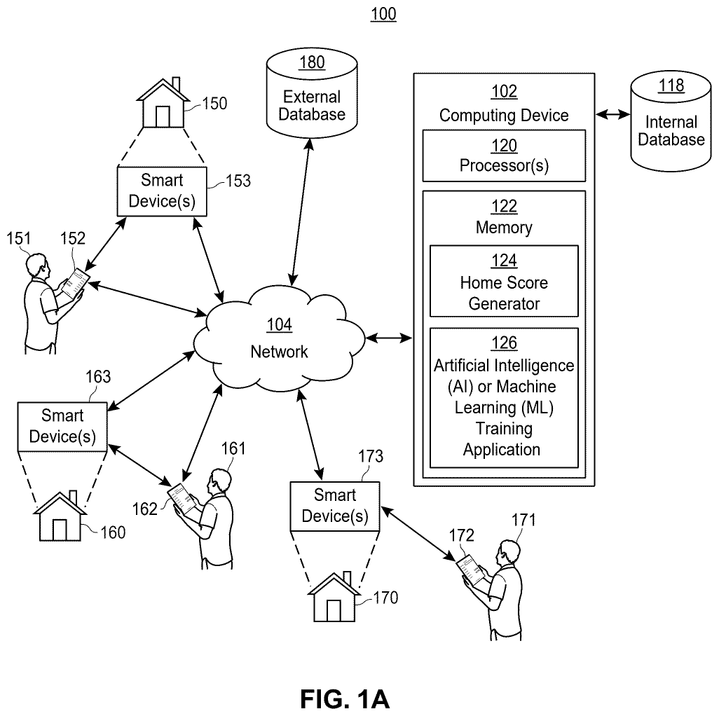

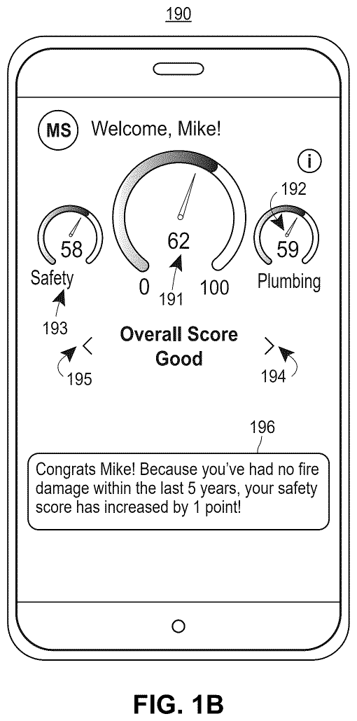

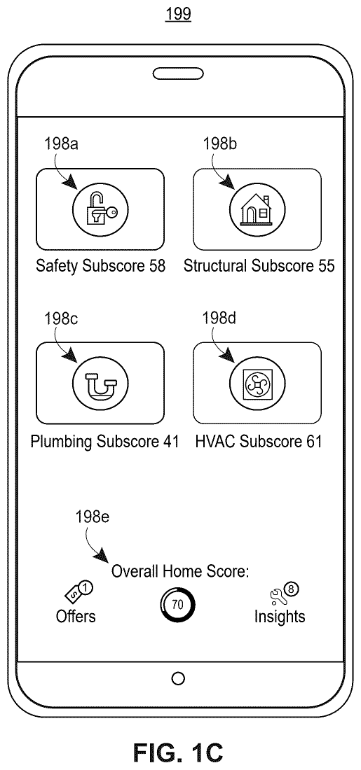

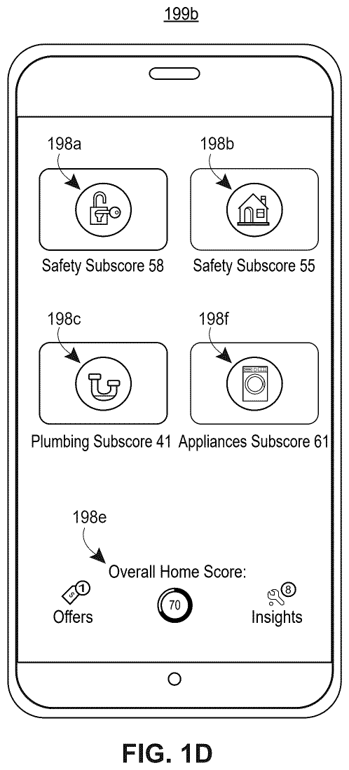

To this end, FIG. 1A illustrates an exemplary computer system 100 for improved determination and display of a home score based upon insurance claim data in which the exemplary computer-implemented methods described herein may be implemented. The high-level architecture includes both hardware and software applications, as well as various data communications channels for communicating data between the various hardware and software components.

The computing device 102 may include one or more processors 120 such as one or more microprocessors, controllers, and/or any other suitable type of processor. The computing device 102 may further include a memory 122 (e.g., volatile memory, non-volatile memory) accessible by the one or more processors 120 (e.g., via a memory controller). The one or more processors 120 may interact with the memory 122 to obtain and execute, for example, computer-readable instructions stored in the memory 122. Additionally or alternatively, computer-readable instructions may be stored on one or more removable media (e.g., a compact disc, a digital versatile disc, removable flash memory, etc.) that may be coupled to the computing device 102 to provide access to the computer-readable instructions stored thereon. In particular, the computer-readable instructions stored on the memory 122 may include instructions for executing various applications, such as home score generator 124, and/or artificial intelligence (AI) or machine learning (ML) training application 126.

An insurance company that owns the computing device 102 may provide insurance, such as homeowners or renters insurance, to the user 151. As such, in some situations, it may be useful for the insurance company to provide discounts on insurance to reward the user for well maintaining their home 150. To this end, it is useful for the insurance company to generate home score(s) for the home 150. Moreover, advantageously, to produce a more accurate home score, the home score generator 124 may modify and/or generate the home score based upon insurance claims data.

To this end, the home score generator 124 may generate and/or modify home score(s). The generation and/or modification of the home score(s) will be described in further detail elsewhere herein. But, by way of brief overview, in some embodiments, the score generator 124 may generate an overall home score based upon a: (i) safety subscore, (ii) structural subscore, (iii) plumbing subscore, (iv) an appliances subscore, and/or (v) HVAC subscore. The home score generator 124 may then modify the overall home score, such as by modifying any of the subscores, based upon insurance claims data. Advantageously, such modification produces a more accurate overall home score.

In some examples, there is a maximum overall home score and/or subscore(s) (e.g., maximum(s) of 10, 100, 1,000, 2,000, 5,000, 10,000, etc.). However, in other examples, there is no maximum overall home score and/or subscore(s).

In some embodiments, the home score(s) are not generated based upon AI and/or ML. However, in other embodiments, the home score(s) are generated based upon AI and/or ML. In some such embodiments, the AI or ML training application 126 may train model(s) and/or algorithm(s) for the home score generator 124 for home score generation. For example, as will be described elsewhere herein, the AI or ML training application 126 may route historical data into the model(s) and/or algorithm(s) for training.

In some embodiments, the home score(s) are generated, at least in part, from sensor data from the home 150, 160, 170. Such sensor data may come from smart device(s) 153, 163, 173.

Furthermore, although the example of FIG. 1A illustrates only one structure on the property 150, any number of structures may be present. For instance, the structures may include a house, a garage, a pool house, a shed, a casita, etc.).

Any of the users 151, 161, 171 may use their respective user devices 152, 162, 172 to view the home score(s) (e.g., via a display of the user device 152, 162, 172). The user devices 152, 162, 172 may be any suitable device, such as a computer, a mobile device, a smartphone, a laptop, a phablet, a chatbot or voice bot, etc. The device may include one or more display devices, one or more processors, one or more memories, etc.

The exemplary system 100 may also include external database 180 and internal database 118. Examples of the data stored by the external database 180 and/or internal database 118 include: insurance claims data; historical information used to train AI and/or ML models and/or algorithms, home score(s) of home(s), etc.

FIG. 1B depicts an exemplary screen 190 (e.g., on a display of any of the user devices 152, 162, 172). Exemplary screen 190 depicts a subject property's 150: (i) overall home score 191; (ii) plumbing subscore 192; and (iii) safety subscore 193. Arrows 194, 195 allow the user 151 to toggle between subscores (e.g., pressing arrow 195 may show the structural subscore, etc.). Text box 196 also includes an explanation of why insurance claim data affected the safety subscore.

FIG. 1C depicts a further exemplary screen 199 (e.g., on a display of any of the user devices 152, 162, 172). Exemplary screen 199 depicts: safety subscore 198a, structural subscore 198b, plumbing subscore 198c, HVAC subscore 198d, and overall home score 198e.

FIG. 1D depicts an exemplary screen 199b (e.g., on a display of any of the user devices 152, 162, 172) including an appliances subscore rather than an HVAC subscore. Exemplary screen 199 depicts: safety subscore 198a, structural subscore 198b, plumbing subscore 198c, appliances subscore 198f, and overall home score 198e.

In addition, further regarding the example system 100, the illustrated exemplary components may be configured to communicate, e.g., via a network 104 (which may be a wired or wireless network, such as the internet), with any other component. Furthermore, although the example system 100 illustrates certain number(s) of each of the components, any number of the example components are contemplated (e.g., any number of users, user devices, homes, smart devices, computing devices, databases, etc.).

### Exemplary Method for Home Score Generation Using an Exemplary Non-AI or ML Technique

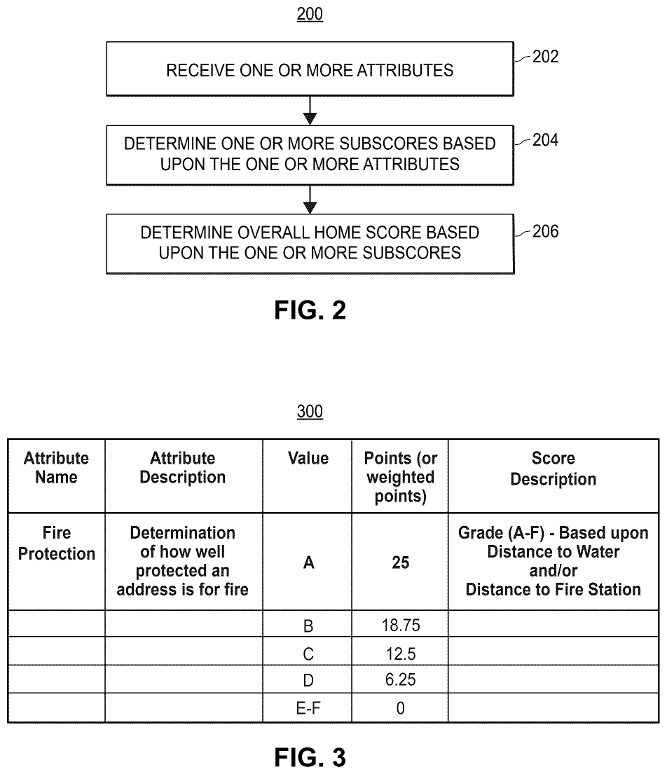

FIG. 2 illustrates a flow diagram representing an exemplary computer-implemented method or implementation 200 for generation of home scores. The exemplary computer-implemented method or implementation 200 may be implemented by a computing environment 100, for example, including the computing device 102, any of the user devices 152, 162, 172, and/or any suitable device including those discussed elsewhere herein, such as one or more local or remote processors, transceivers, memory units, sensors, mobile devices, unmanned aerial vehicles (e.g., drones), etc. In some embodiments, the exemplary computer-implemented method or implementation 200 may be implemented by the home score generator 124.

The exemplary computer-implemented method or implementation 200 may begin at block 202 when the one or more processors 120 receive one or more attributes. Examples of the one or more attributes include (i) safety attribute(s), (ii) structural attribute(s), (iii) plumbing attribute(s), (iv) appliances attribute(s), and/or (v) HVAC attribute(s).

In some examples, the safety attribute(s) include fire protection attribute(s), weather hazard attribute(s), crime attribute(s), and/or other hazard attributes. Any or all of the attributes may be valued (e.g., measured, etc.) in the form of a “grade.” In this regard, such attributes may be “categorical” attributes. In some examples, the grades may be letter grades of A through F. Further, the grades may be assigned numerical scores. In some examples, the grades are assigned by human experts. The assigned grades and/or categorical values may then be stored in a database (e.g., external database 180 and/or internal database 118), and/or sent directly to any other component in FIG. 1A.

By way of exemplary illustration, FIG. 3 shows an exemplary table 300 indicating information of an exemplary fire protection attribute. The attribute may have a name, which, in the illustrated example, is a fire protection attribute. The exemplary attribute may be assigned a grade (e.g., a value), such as a grade of A through F. The grade/value may further be assigned points and/or weighted points. For instance, in the illustrated example, a grade of A may be assigned 12.5 points; a grade of B may be assigned 9.375 points; a grade of C may be assigned 6.25 points; a grade of D assigned 3.125 points; and/or a grade of E or F assigned 0 points. In some embodiments, the fire protection attribute additionally or alternatively includes a grade based upon a distance from a property to water and/or a distance from the property to a fire station. The grade based upon a distance from a property to water and/or a distance from the property to a fire station may be assigned points similarly to the example of FIG. 3. In some examples, the grade is assigned to the home by a human knowledgeable with respect to homes and/or fire safety.

In some examples, the weather hazard attributes include: an earthquake grade, a wind grade, a hail grade, a tornado grade, a lightning grade, a flood grade, a wildfire grade, a drought grade, a tsunami grade, a hurricane grade, a volcano grade, a wind born debris grade, a costal storm surge grade, a freezing weather grade, and/or a convection storm grade.

In some examples, the crime attributes include a burglary grade based upon a burglary likelihood, and/or a motor vehicle theft grade based upon a motor vehicle theft likelihood.

In some examples, the other hazard attributes include a grade based upon other hazards, such as presence of an uncovered pool, a pool without a fence, radon, gas, a trampoline, etc.

In some examples, the structural attributes include a structural grade, and/or a home age.

In some examples, the plumbing attributes include a plumbing grade, and/or a date of a most recent plumbing inspection.

In some examples, the appliances attributes include an energy grade (e.g., a grade rating how energy efficient the property 150 is), an appliances maintenance grade, HVAC attributes, and/or an age of an HVAC unit. The energy grade may be a rating based upon one or more appliances of the property 150 and/or based upon an overall energy use of the property 150. The appliances maintenance grade may be a rating based upon, for example, types of appliances, dates of when maintenance was performed on appliances, types of maintenance performed on the appliances, etc. In some examples, the appliances maintenance grade may include individual grades of respective appliances that are summed, averaged, etc. For example, the appliances maintenance grade may include a smart washing machine maintenance grade averaged with a smart dryer maintenance grade.

In some examples, the HVAC attributes include a HVAC grade, and/or an age of an HVAC unit. In some examples, the HVAC unit comprises a furnace, a heat pump, a gas or electric water heater, an evaporative cooler, and/or an air conditioning (AC) condenser.

Moreover, it should be appreciated that any of the grades mentioned above may be assigned points similarly to the example of FIG. 3.

Returning now to FIG. 2, at block 204, the one or more processors 120 may determine one or more of the subscores based upon the attribute(s). In some examples, the subscores are determined based upon points assigned to the attribute. For instance, with respect to the example of FIG. 3, if the only safety attribute is the fire protection attribute and the home has been assigned a grade of “C,” the safety subscore may be determined to be 12.5. In other examples, attributes may be summed, averaged, etc., to determine the respective subscores.

Furthermore, attributes and/or grades may be weighted. For example, if the weather hazard attribute includes an earthquake grade and a wind grade, the wind grade may be weighted more than the earthquake grade in determining the weather hazard subscore.

In some embodiments, when values are missing (e.g., NaN, etc.), they may be filled in with a neutral value. For instance, with respect to the example of FIG. 3, if any of the values corresponding to attributes with a grade (A-F) are missing, they may be filled in with a value of C.

In some embodiments, the subscores may be further modified by sensor data (e.g., from any of the smart devices 153, 163, 173, etc.). For example, data received from a water flow sensor may increase a plumbing subscore (e.g., confirming that the water flow sensor is operating properly based upon the sensor data may increase the plumbing subscore). In another example, data from an airflow sensor may increase an HVAC subscore (e.g., confirming that the airflow sensor is operating properly based upon the sensor data may increase the HVAC subscore).

In some embodiments, extra points may be given to any of the subscores based upon a user 151 returning to the app. For example, if the user 151 has not logged into the app for a predetermined period of time (e.g., a week, a month, a year, etc.), any of the subscores may be increased.

At block 206, the overall home score is determined based upon the subscores. For example, any or all of the (i) safety subscore, (ii) structural subscore, (iii) plumbing subscore, (vi) appliances subscore, and/or (v) HVAC subscore may be averaged or summed to determine the overall home score. In examples where only one subscore is available or has been calculated, the overall home score may be determined to be the subscore that is available.

In some embodiments, extra points may be given to the overall subscore based upon the user 151 returning to the app. For example, if the user 151 has not logged into the app for a predetermined period of time (e.g., a week, a month, a year, etc.), the overall home score may be increased.

### Exemplary Method for Home Score Generation Using an Exemplary AI or ML Technique

Broadly speaking, AI and/or ML algorithm(s) and/or model(s) may be used to determine any of the overall home score and/or the home subscores. Although the following discussion refers to an ML algorithm (or ML model), it should be appreciated that it applies equally to ML and/or AI algorithms and/or models.

In some embodiments, individual machine learning algorithms are used to determine the subscores, and then the subscores are aggregated together (e.g., by averaging, taking a weighted average, summing, etc.) to determine the overall home score. To this end, in some examples: the safety subscore is calculated via a safety subscore machine learning algorithm; the structural subscore is calculated via a structural subscore machine learning algorithm; the plumbing subscore is calculated via a plumbing subscore machine learning algorithm; the appliances subscore is calculated via an appliances subscore machine learning algorithm; and/or the HVAC subscore is calculated via a HVAC subscore learning algorithm.

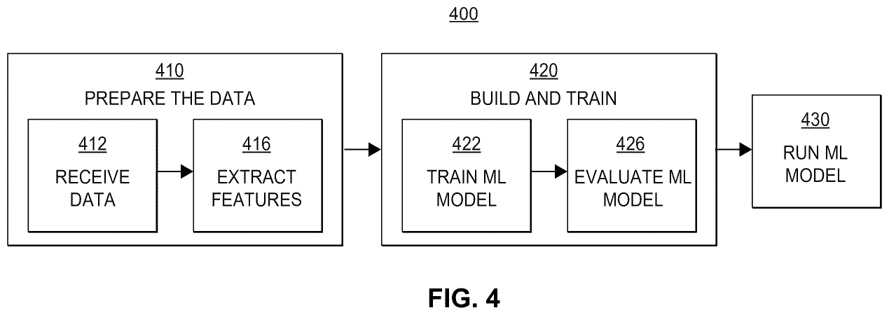

FIG. 4 is a block diagram of an exemplary machine learning modeling method 400 for training and evaluating a ML algorithm (e.g., an overall home score ML algorithm, a safety subscore ML algorithm, a structural subscore ML algorithm, a plumbing subscore ML algorithm, an appliances subscore ML algorithm, and/or a HVAC ML algorithm, etc.) (e.g., implemented by the AI or ML training application 126), in accordance with various embodiments. In some embodiments, the model “learns” an algorithm capable of performing the desired function, such as determining any of the overall home score, the safety subscore, the structural subscore, the plumbing subscore, the appliances subscore, and/or the HVAC subscore. It should be understood that the principles of FIG. 4 may apply to any machine learning algorithm discussed herein.

Although the following discussion refers to the blocks of FIG. 4 as being performed by the one or more processors 120, it should be appreciated that the blocks of FIG. 4 may be performed by any suitable component or combinations of components (e.g., the one or more processors of the user device 152, 162, 172, etc.).

At a high level, the machine learning modeling method 400 includes a block 410 to prepare the data, a block 420 to build and train the model, and a block 430 to run the model.

Block 410 may include sub-blocks 412 and 416. At block 412, the one or more processors 120 may receive (e.g., from the external database 180, the internal database 118, etc.) the historical information to train the machine learning algorithm. In some examples, the historical information comprises: (i) inputs to the machine learning model (e.g., also referred to as independent variables, or explanatory variables), and/or (ii) outputs of the machine learning model (e.g., also referred to as dependent variables, or response variables). In some such examples, the dependent variables are the scores that the ML algorithm is trained to determine (e.g., the dependent variable of the safety subscore ML algorithm is the safety subscore); and the independent variables are used to determine the dependent variables (e.g., independent variables to the plumbing subscore ML algorithm are historical plumbing grades, and historical dates of most recent plumbing inspections, etc.). Put another way, the independent variables may have an impact on the dependent variables; and the ML algorithms may be trained to find this impact. Therefore, when using a trained ML algorithm to determine a score, information of the home corresponding to the historical information that the ML was trained on may be routed into the ML algorithm to determine the score/subscore.

More specifically, for the historical information used to train the safety subscore machine learning algorithm, examples of the historical information include historical: (i) independent variables comprising (a) historical fire protection attributes, (b) historical weather hazard attributes, (c) historical crime attributes, (d) historical other hazard attributes, and/or (e) historical insurance claim data; and/or (ii) dependent variables comprising historical safety subscores.

For the historical information used to train the structural machine learning algorithm, examples of the historical information include historical: (i) independent variables including: (a) historical structural grades, (b) historical home ages, and/or (c) historical insurance claim data; and/or (ii) dependent variables comprising historical structural subscores.

For the historical information used to train the plumbing subscore machine learning algorithm, examples of the historical information include historical: (i) independent variables including: (a) historical plumbing grades, (b) historical dates of most recent plumbing inspections, and/or (c) historical insurance claim data; and/or (ii) dependent variables comprising historical plumbing subscores.

For the historical information used to train the appliances subscore machine learning algorithm examples of the historical information include historical: (i) independent variables including (a) historical energy grades, (b) historical appliances maintenance grades, and/or (c) historical heating, ventilation, and air conditioning (HVAC) attributes, and/or (ii) dependent variables comprising historical appliances subscores.

For the historical information used to train the HVAC subscore machine learning algorithm, examples of the historical information include historical: (i) independent variables including: (a) historical HVAC grades, (b) historical ages of HVAC units, and/or (c) historical insurance claim data; and/or (ii) dependent variables comprising historical HVAC subscores.

Block 420 may include sub-blocks 422 and 426. At block 422, the ML model is trained (e.g. based upon the data received from block 410). In some embodiments where associated information is included in the historical information, the ML model “learns” an algorithm capable of calculating or predicting the target feature values (e.g., determining home score(s), etc.) given the predictor feature values.

At block 426, the one or more processors 120 may evaluate the machine learning model, and determine whether or not the machine learning model is ready for deployment.

Further regarding block 426, evaluating the model sometimes involves testing the model using testing data or validating the model using validation data. Testing/validation data typically includes both predictor feature values and target feature values (e.g., including known inputs and outputs), enabling comparison of target feature values predicted by the model to the actual target feature values, enabling one to evaluate the performance of the model. This testing/validation process is valuable because the model, when implemented, will generate target feature values for future input data that may not be easily checked or validated.

Thus, it is advantageous to check one or more accuracy metrics of the model on data for which the target answer is already known (e.g., testing data or validation data, such as data including historical information, such as the historical information discussed above), and use this assessment as a proxy for predictive accuracy on future data. Exemplary accuracy metrics include key performance indicators, comparisons between historical trends and predictions of results, cross-validation with subject matter experts, comparisons between predicted results and actual results, etc.

In some embodiments, ML algorithms are used to determine the subscores, and then the subscores are averaged or summed to determine the overall home score.

In some embodiments, ML algorithms are used to determine the subscores, and then the overall home score is determined by taking a weighted average of the subscores. The weights may be determined by any suitable technique. For example, the weights may be based upon geographic region of the home, time of year, climate data, weather data, etc. In one working example, in a geographic region known for wildfires, during the wildfire season, the safety subscore may be given a greater weight than during the non-wildfire season.

Advantageously, using separate machine learning algorithms to determine individual subscores, and then determining the overall home score based upon the subscores improves accuracy of the overall home score determination, thereby improving technical functioning.

Moreover, it should be appreciated that the ML algorithm(s) may be any kind of ML algorithms (e.g., neural networks, convolutional neural networks, deep learning algorithms, etc.).

Exemplary Method for Improved Determination and/or Display of a Home Score Based Upon Insurance Claim Data

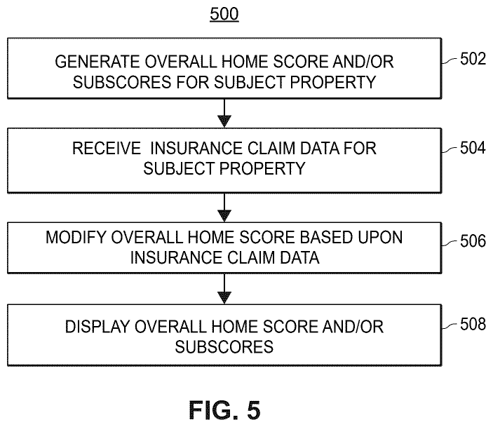

FIG. 5 illustrates a flow diagram representing an exemplary computer-implemented method or implementation 500 for improved determination and/or display of a home score based upon insurance claim data. The exemplary method 500 may be implemented by a computing environment 100, for example, including the computing device 102, any of the user devices 152, 162, 172, and/or any suitable device including those discussed elsewhere herein, such as one or more local or remote processors, transceivers, memory units, sensors, mobile devices, unmanned aerial vehicles (e.g., drones), etc.

The exemplary computer-implemented method or implementation 500 may begin at block 502 when the one or more processors 120 generate (e.g., via the home score generator 124) (or receive, e.g., from external database 180, etc.) a home score (e.g., an overall home score and/or any of the subscores discussed herein) for a subject property (e.g., home 150, etc.). The home score may be or have been generated in accordance with the techniques described herein (e.g., using one or both of a non-ML and/or ML technique, e.g., such as described above with respect to FIGS. 2-4, etc.).

Furthermore, at block 502 the home score may be updated and/or generated based upon the user 151 completing insights (e.g., recommendations for home projects to improve her home score, etc.). For example, if a user 151 replaces her smoke detector battery, her safety subscore may increase by 1 point, etc.

Examples of the insights include: replacing a smoke detector battery; installing a support beam; replacing at least one pipe; replacing an air filter; and/or installing a water sensor.

In some examples, any of all of the insights may be emergency preparedness insights. For instance, an emergency preparedness may help a user 151 prepare for a weather event (e.g., a storm, hurricane, hailstorm, snowstorm, etc.), or other emergency (e.g., wildfire, earthquake, etc.). In some such examples, the insight is presented to the user 151 further based upon a season. For example, during winter, an insight to winterize pipes may be presented. Additionally or alternatively, insights may be presented in response to prediction of an event. For example, in response to a prediction that a storm will occur, an insight(s) to install stronger windows, and/or repair a wall and/or roof may be presented.

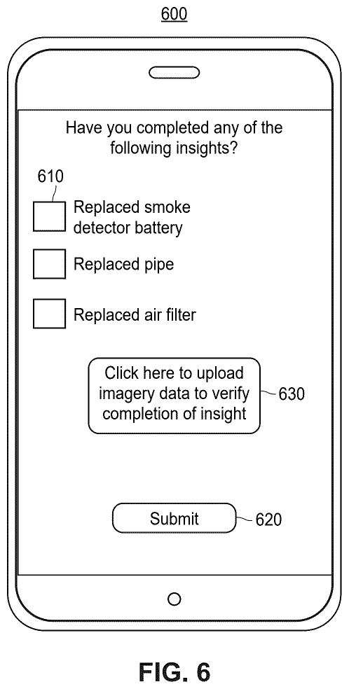

FIG. 6 depicts an exemplary screen allowing a user 151 to indicate completion of one or more insights. For example, the user 151 may indicate that she has replaced a smoke detector battery by marking the checkbox 610, and pressing submit button 620. In some examples, the system may also indicate how much each insight will increase the overall home score and/or subscores by. In one example, next to an insight of “replaced pipe,” “+1 point to your plumbing subscore” may be displayed.

In some embodiments, the user 151 must verify that she has completed the insight by uploading imagery data (e.g., image data and/or video data). To this end, button 630 allows the user 151 to upload such imagery data. Additionally or alternatively, the user 151 may be prompted to enter the imagery data upon pressing the submit button 620.

In some embodiments, the overall home score or any of the subscores may be reduced if the user 153 does not complete the insight within a predetermined completion time period (e.g., HVAC subscore reduced if air filter is not replaced upon expiration of a predetermined completion time period, etc.).

At block 504, the one or more processors 120 receive insurance claim data for an insurance claim corresponding to the subject property 150. The insurance claim data may include data from one or more insurance claims (e.g., homeowners insurance, renters insurance, etc.); alternatively, the insurance claim data may indicate that no insurance claims have been filed for the subject property 150. In some examples, the insurance claim data includes: (i) monetary amounts of insurance claims (e.g., amounts an insurance company paid for the insurance claims); and/or (ii) category of insurance claims.

Examples of the categories include: a fire damage category; a water damage category; an ice damage category; a hail damage category; a wind damage category; a crime category; a total loss category; and/or a personal liability category (e.g., tripping, pools, trampoline accidents, etc.).

At block 506, the one or more processors 120 modify the overall home score based upon the insurance claim data. In some examples, this includes first modifying one or more of the subscores, and then updating the overall home score based upon the modified subscore. In one such example, the insurance claim data indicates that no insurance claims in the fire damage category have been placed within a predetermined time period; and, in response, the one or more processors 120 increase the safety subscore, and then update the overall home score based upon the increased safety subscore.

In some examples, the subscore and/or overall home score is modified proportionally to a monetary amount of the insurance claim. For example, an insurance claim with a lower monetary amount may modify a subscore less than an insurance claim with a larger monetary amount.

Additionally or alternatively, in some examples, the modification is based upon a time that the insurance claim was placed.

For example, if the insurance claim data indicates that no insurance claim has ever been placed on the subject property 150, the overall home score may be increased, and/or any of the subscores may be increased.

In another example, following a first insurance claim, the one or more processors 120 may determine that the subject property 150 has not had an additional insurance claim filed within a predetermined time period; and, in response to the determination that the subject property has not had the additional insurance claim filed within the predetermined time period, the one or more processors 120 may increase the overall home score and/or increase any of the subscores.

In another example, the overall home score and/or subscores are only modified by insurance claims within a predetermined time period. For instance, it may be desired to update the overall home score and/or subscore only with recent insurance claims. For example, it may be desired to update the overall home score and/or subscore only with claims within the past two years; in this example, if the insurance claims data includes claims placed both inside and outside of the two-year time window from the current date, only the claims placed within the past two years will be used to modify the overall homes score and/or subscores.

In some examples, the modification is also based upon the category of the insurance claim. For example, if a property has had an insurance claim placed for hail damage, the safety subscore may be modified.

In some examples, the modification is based upon both the category of the insurance claim, and a geographic area that the subject property 150 is in. For example, an insurance claim in the ice damage category may affect the overall home score and/or subscores differently if the subject property 150 is located in Texas (e.g., a geographic area where ice damage is not common, etc.) than if the subject property is located in Wisconsin (e.g., a geographic area where ice damage is more common, etc.).

In some examples, the modification is based upon a seasonal time period and/or seasonal category. For example, the overall home score and/or subscores may be modified more (or less) if an insurance claim is placed during a particular season (e.g., within a range of dates in a year, etc.). In some such embodiments, to make an additional modification to the overall home score and/or subscores, the insurance claim must also be in a seasonal category (e.g., ice claim category placed during the winter, etc.).

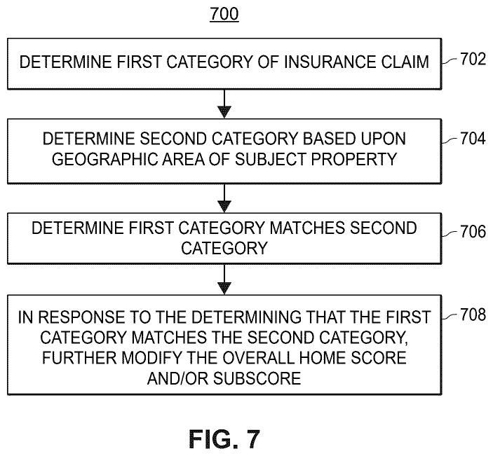

FIG. 7 depicts an exemplary method 700 of modifying the home score based upon the geographic area of the subject property 150 and/or a seasonal category. At block 702, the one or more processors 120 determine a first category (e.g., a category of an insurance claim received at block 504, etc.). At block 704, the one or more processors 120 determine a second category (e.g., a category based upon a geographic area of the subject property 150, and/or a seasonal category, etc.).

At block 706, the one or more processors 120 determine that the first category matches the second category. At block 708, the one or more processors 120, in response to the determining that the first category matches the second category, further modify the overall home score and/or subscores.

In addition, if it is determined that the first category does not match the second category (e.g., at block 706), the process 700 may iterate back to block 702 to determine a category of a next insurance claim (e.g., the insurance claim data received at block 504 includes multiple insurance claims, etc.). Alternatively (e.g., if there are no more insurance claims to check), the process may continue with the modification at block 506, or continue to block 508.

Following the modification, the one or more processors 120 display the overall home score and/or any of the subscores (e.g., on a display of a user device, such as user devices 152, 162, 172, etc.). An explanation of how the insurance claim data affected the overall home score or any of the subscores may also be displayed, such as in the example of FIG. 1B.

It should be understood that not all blocks and/or events of the exemplary signal diagrams and/or flowcharts are required to be performed. Moreover, the exemplary signal diagrams and/or flowcharts are not mutually exclusive (e.g., block(s)/events from each example signal diagram and/or flowchart may be performed in any other signal diagram and/or flowchart). The exemplary signal diagrams and/or flowcharts may include additional, less, or alternate functionality, including that discussed elsewhere herein.

### Additional Exemplary Embodiments

In one aspect, a computer-implemented method for improved determination and display of a home score based upon insurance claim data may be provided. The method may be implemented via one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For instance, in one example, the method may include: (1) generating, via one or more processors, an overall home score for a subject property; (2) receiving, via the one or more processors, insurance claim data for an insurance claim corresponding to the subject property, wherein the insurance claim data includes (i) a monetary amount of the insurance claim, and/or (ii) a category of the insurance claim; (3) modifying, via the one or more processors, the overall home score based upon the insurance claim data; and/or (4) displaying, via the one or more processors, the overall home score. The method may include additional, fewer, or alternate actions, including those discussed elsewhere herein.

In some embodiments, the method further includes: prior to the modifying the overall home score, modifying, via the one or more processors, a subscore of the overall home score based upon the insurance claim data; and/or wherein the modifying the overall home score includes modifying the overall home score based upon the modified subscore.

In some embodiments, the modifying includes modifying the overall home score based upon the category of the insurance claim, and/or wherein the category is at least one of: a fire damage category; a water damage category; an ice damage category; a hail damage category; a wind damage category; a crime category; a total loss category and/or a personal liability category (e.g., tripping, pools, trampoline accidents, etc.).

In some embodiments, the modifying the overall home score includes modifying, via the one or more processors, the overall home score proportionally to the monetary amount of the insurance claim.

In some embodiments, the method further includes: determining, via the one or more processors, that the subject property has not had an additional insurance claim filed within a predetermined time period; and/or in response to the determination that the subject property has not had the additional insurance claim filed within the predetermined time period, increasing, via the one or more processors, the overall home score by a predetermined amount.

In some embodiments, the category is a first category, and the method further includes: determining, via the one or more processors, a second category based upon a geographic area of the subject property; determining, via the one or more processors, that the first category matches the second category; and/or in response to the determining that the first category matches the second category, further modifying, via the one or more processors, the overall home score.

In some embodiments, the insurance claim data includes data for a plurality of insurance claims, and the insurance claim is included in the plurality of insurance claims; and/or the method further includes: determining, via the one or more processors, insurance claims of the plurality of insurance claims within a predetermined time period; modifying, via the one or more processors, the overall home score based upon data of the insurance claims determined to be within the predetermined time period; and/or not modifying, via the one or more processors, the overall home score based upon data of the insurance claims determined not to be within the predetermined time period.

In some embodiments, the insurance claim data includes data for a plurality of insurance claims, and/or the insurance claim is included in the plurality of insurance claims; and/or the method further includes: receiving, via the one or more processors, a seasonal predetermined time period, and/or a seasonal category; determining, via the one or more processors, that no insurance claims of the plurality of insurance claims were: (i) placed within the seasonal predetermined time period, and/or (ii) have a same category as the seasonal category; and/or in response to the determination that no insurance claims of the plurality of insurance claims were: (i) placed within the seasonal predetermined time period, and/or (ii) have the same category as the seasonal category, increasing, via the one or more processors, the overall home score.

In some embodiments, the generating includes generating the overall home score based upon a safety subscore of the subject property, and wherein the method further includes determining, via the one or more processors, the safety subscore based upon: fire protection attributes, weather hazard attributes, and/or crime attributes.

In some embodiments, the fire protection attributes include a grade based upon a distance from a property to water and/or a distance from the property to a fire station; the weather hazard attributes include: an earthquake grade, a wind grade, a hail grade, a tornado grade, a lightning grade, a flood grade, a wildfire grade, a drought grade, a tsunami grade, a hurricane grade, a volcano grade, a wind born debris grade, a costal storm surge grade, and/or a convection storm grade; and/or the crime attributes include (i) a burglary grade based upon a burglary likelihood, and/or (ii) a motor vehicle theft grade based upon a motor vehicle theft likelihood.

In some embodiments, the generating includes generating the overall home score based upon a structural subscore of the subject property, and/or wherein the method further includes determining, via the one or more processors, the structural subscore based upon: a structural grade, and/or a home age.

In some embodiments, the generating includes generating the overall home score based upon a plumbing subscore of the subject property, and/or wherein the method further includes determining, via the one or more processors, the plumbing subscore based upon: a plumbing grade, and/or a date of a most recent plumbing inspection.

In some embodiments, the generating includes generating the overall home score based upon an appliances subscore of the subject property, and/or wherein the method further includes determining, via the one or more processors, the appliances subscore based upon: an energy grade, an appliances maintenance grade, and/or a heating, ventilation, and air conditioning (HVAC) attribute.

In some embodiments, the generating includes generating the overall home score based upon a HVAC subscore of the subject property, and/or wherein the method further includes determining, via the one or more processors, the HVAC subscore based upon: a HVAC grade, and/or an age of an HVAC unit.

In some embodiments, the method further includes: presenting, via the one or more processors, one or more insights to a user corresponding to the subject property; receiving, via the one or more processors, from the user, an indication that at least one insight of the one or more insights has been completed; and/or in response to receiving the indication, updating, via the one or more processors, the overall home score for the subject property.

In some embodiments, the one or more insights include: replacing a smoke detector battery; installing a support beam; replacing at least one pipe; replacing an air filter; and/or installing a water sensor.

In some embodiments, the method further includes: presenting, via the one or more processors, one or more insights to a user corresponding to the subject property; receiving, via the one or more processors, from the user, an indication that at least one insight of the one or more insights has been completed; in response to receiving the indication, requesting, via the one or more processors, from the user, imagery data associated with the at least one insight; receiving, via the one or more processors, the imagery data from the user; verifying, via the one or more processors, that the at least one insight has been completed based upon the imagery data; and/or in response to the verification, updating, via the one or more processors, the overall home score for the subject property.

In some embodiments, the generating includes generating the overall home score based upon a safety subscore of the subject property, and/or the method further includes: training a safety subscore machine learning algorithm by inputting historical information into the safety subscore machine learning algorithm, the historical information including: (i) independent variables comprising (a) historical fire protection attributes, (b) historical weather hazard attributes, (c) historical crime attributes, (d) historical other hazard attributes, and/or (e) historical insurance claim data; and/or (ii) dependent variables comprising historical safety subscores; and/or determining the safety subscore by routing information of properties into the trained safety subscore machine learning algorithm.

In some embodiments, the generating includes generating the overall home score based upon a structural subscore of the subject property, and/or the method further includes: training a structural subscore machine learning algorithm by inputting historical information into the structural subscore machine learning algorithm, the historical information comprising: (i) independent variables including: (a) historical structural grades, (b) historical home ages, and/or (c) historical insurance claim data; and/or (ii) dependent variables comprising historical structural subscores; and/or determining the structural subscore by routing information of properties into the trained structural subscore machine learning algorithm.

In some embodiments, the generating includes generating the overall home score based upon a plumbing subscore of the subject property, and/or the method further includes: training a plumbing subscore machine learning algorithm by inputting historical information into the plumbing subscore machine learning algorithm, the historical information comprising: (i) independent variables including: (a) historical plumbing grades, (b) historical dates of a most recent plumbing inspections, and/or (c) historical insurance claim data; and/or (ii) dependent variables comprising historical plumbing subscores; and/or determining the plumbing subscore by routing information of properties into the trained plumbing subscore machine learning algorithm.

In some embodiments, the generating includes generating the overall home score based upon a HVAC subscore of the subject property, and/or the method further includes: training a HVAC subscore machine learning algorithm by inputting historical information into the HVAC subscore machine learning algorithm, the historical information comprising: (i) independent variables including: (a) historical HVAC grades, (b) historical ages of HVAC units, and/or (c) historical insurance claim data; and/or (ii) dependent variables comprising historical HVAC subscores; and/or determining the HVAC subscore by routing information of properties into the trained HVAC subscore machine learning algorithm.

In some embodiments, the generating includes generating the overall home score based upon one more subscores including: (i) a safety subscore, (ii) a structural subscore, (iii) a plumbing subscore, and/or (iv) a heating, ventilation, and air conditioning (HVAC) subscore.

In another aspect, a computer device configured for improved determination and display of a home score based upon insurance claim data may be provided. The computer device may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components, which may be in wired or wireless communication with one another. For example, in one instance, the computer device may include one or more processors configured to: (1) generate an overall home score for a subject property; (2) receive insurance claim data for an insurance claim corresponding to the subject property, wherein the insurance claim data includes (i) a monetary amount of the insurance claim, and/or (ii) a category of the insurance claim; (3) modify the overall home score based upon the insurance claim data; and/or (4) display the overall home score. The computer device may include additional, less, or alternate functionality, including that discussed elsewhere herein.

In some embodiments, the one or more processors are further configured to: present one or more insights to a user corresponding to the subject property; and/or if an indication received from the user indicates that at least one insight of the one or more insights has been completed, update the overall home score for the subject property.

In some embodiments, the one or more insights include: replacing a smoke detector battery; installing a support beam; replacing at least one pipe; replacing an air filter; and/or installing a water sensor.

In yet another aspect, a computer system configured for improved determination and display of a home score based upon insurance claim data may be provided. The computer system may include one or more local or remote processors, sensors, transceivers, servers, memory units, augmented reality (AR) glasses or headsets, virtual reality headsets, extended or mixed reality headsets, smart glasses or watches, wearables, voice bot or chatbot, ChatGPT bot, airplanes, satellites, drones or other unmanned aerial vehicles (UAVs), and/or other electronic or electrical components. For instance, in one example, the computer system may include: one or more processors; and/or one or more non-transitory memories coupled to the one or more processors. The one or more non-transitory memories may include computer-executable instructions stored therein that, when executed by the one or more processors, may cause the one or more processors to: (1) generate an overall home score for a subject property; (2) receive insurance claim data for an insurance claim corresponding to the subject property, wherein the insurance claim data includes (i) a monetary amount of the insurance claim, and/or (ii) a category of the insurance claim; (3) modify the overall home score based upon the insurance claim data; and/or (4) display the overall home score. The computer system may include additional, less, or alternate functionality, including that discussed elsewhere herein.

In some embodiments, the one or more non-transitory memories having stored thereon computer-executable instructions that, when executed by the one or more processors, cause the one or more processors to: present one or more insights to a user corresponding to the subject property; if an indication received from the user indicates that at least one insight of the one or more insights has been completed, request, from the user, imagery data associated with the at least one insight; receive the imagery data from the user; verify that the at least one insight has been completed based upon the imagery data; and/or in response to the verification, update the overall home score for the subject property.

### Other Matters

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for improved determination and display of a home score based upon insurance claim data, the method comprising:
generating, via one or more processors, an overall home score for a subject property;
receiving, via the one or more processors, insurance claim data for an insurance claim corresponding to the subject property, wherein the insurance claim data includes (i) a monetary amount of the insurance claim, and/or (ii) a category of the insurance claim;
modifying, via the one or more processors, the overall home score based upon the insurance claim data; and
displaying, via the one or more processors, the overall home score.

2. The computer-implemented method of claim 1, further including:
prior to the modifying the overall home score, modifying, via the one or more processors, a subscore of the overall home score based upon the insurance claim data;
wherein the modifying the overall home score includes modifying the overall home score based upon the modified subscore.

3. The computer-implemented method of claim 1, wherein the modifying includes modifying the overall home score based upon the category of the insurance claim, and wherein the category is at least one of:
a fire damage category;
a water damage category;
an ice damage category;
a hail damage category;
a wind damage category;
a crime category;
a total loss category; and/or
a personal liability category.

4. The computer-implemented method of claim 1, wherein the modifying the overall home score includes modifying, via the one or more processors, the overall home score proportionally to the monetary amount of the insurance claim.

5. The computer-implemented method of claim 1, further including:
determining, via the one or more processors, that the subject property has not had an additional insurance claim filed within a predetermined time period; and
in response to the determination that the subject property has not had the additional insurance claim filed within the predetermined time period, increasing, via the one or more processors, the overall home score by a predetermined amount.

6. The computer-implemented method of claim 1, wherein the category is a first category, and the method further includes:
determining, via the one or more processors, a second category based upon a geographic area of the subject property;
determining, via the one or more processors, that the first category matches the second category; and
in response to the determining that the first category matches the second category, further modifying, via the one or more processors, the overall home score.

7. The computer-implemented method of claim 1, wherein:
the insurance claim data includes data for a plurality of insurance claims, and the insurance claim is included in the plurality of insurance claims; and
the method further includes:
determining, via the one or more processors, insurance claims of the plurality of insurance claims within a predetermined time period;
modifying, via the one or more processors, the overall home score based upon data of the insurance claims determined to be within the predetermined time period; and
not modifying, via the one or more processors, the overall home score based upon data of the insurance claims determined not to be within the predetermined time period.

8. The computer-implemented method of claim 1, wherein:
the insurance claim data includes data for a plurality of insurance claims, and the insurance claim is included in the plurality of insurance claims; and
the method further includes:
receiving, via the one or more processors, a seasonal predetermined time period, and a seasonal category;
determining, via the one or more processors, that no insurance claims of the plurality of insurance claims were: (i) placed within the seasonal predetermined time period, and/or (ii) have a same category as the seasonal category; and
in response to the determination that no insurance claims of the plurality of insurance claims were: (i) placed within the seasonal predetermined time period, and/or (ii) have the same category as the seasonal category, increasing, via the one or more processors, the overall home score.

9. The computer-implemented method of claim 1, wherein the generating includes generating the overall home score based upon a safety subscore of the subject property, and wherein the method further includes determining, via the one or more processors, the safety subscore based upon: fire protection attributes, weather hazard attributes, and/or crime attributes.

10. The computer-implemented method of claim 9, wherein:
the fire protection attributes include a grade based upon a distance from a property to water and/or a distance from the property to a fire station;
the weather hazard attributes include: an earthquake grade, a wind grade, a hail grade, a tornado grade, a lightning grade, a flood grade, a wildfire grade, a drought grade, a tsunami grade, a hurricane grade, a volcano grade, a wind born debris grade, a costal storm surge grade, and/or a convection storm grade; and
the crime attributes include (i) a burglary grade based upon a burglary likelihood, and/or (ii) a motor vehicle theft grade based upon a motor vehicle theft likelihood.

11. The computer-implemented method of claim 1, wherein the generating includes generating the overall home score based upon a structural subscore of the subject property, and wherein the method further includes determining, via the one or more processors, the structural subscore based upon: a structural grade, and/or a home age.

12. The computer-implemented method of claim 1, wherein the generating includes generating the overall home score based upon a plumbing subscore of the subject property, and wherein the method further includes determining, via the one or more processors, the plumbing subscore based upon: a plumbing grade, and/or a date of a most recent plumbing inspection.

13. The computer-implemented method of claim 1, wherein the generating includes generating the overall home score based upon an appliances subscore of the subject property, and wherein the method further includes determining, via the one or more processors, the appliances subscore based upon: an energy grade, an appliances maintenance grade, and/or a heating, ventilation, and air conditioning (HVAC) attribute.

14. The computer-implemented method of claim 1, wherein the generating includes generating the overall home score based upon a safety subscore of the subject property, and the method further includes:
training a safety subscore machine learning algorithm by inputting historical information into the safety subscore machine learning algorithm, the historical information including: (i) independent variables comprising (a) historical fire protection attributes, (b) historical weather hazard attributes, (c) historical crime attributes, and/or (d) historical insurance claim data; and/or (ii) dependent variables comprising historical safety subscores; and
determining the safety subscore by routing information of properties into the trained safety subscore machine learning algorithm.

15. The computer-implemented method of claim 1, wherein the generating includes generating the overall home score based upon a structural subscore of the subject property, and the method further includes:
training a structural subscore machine learning algorithm by inputting historical information into the structural subscore machine learning algorithm, the historical information comprising: (i) independent variables including: (a) historical structural grades, (b) historical home ages, and/or (c) historical insurance claim data; and/or (ii) dependent variables comprising historical structural subscores; and
determining the structural subscore by routing information of properties into the trained structural subscore machine learning algorithm.

16. A computer device for improved determination and display of a home score based upon insurance claim data, the computer device comprising one or more processors configured to:
generate an overall home score for a subject property;
receive insurance claim data for an insurance claim corresponding to the subject property, wherein the insurance claim data includes (i) a monetary amount of the insurance claim, and/or (ii) a category of the insurance claim;
modify the overall home score based upon the insurance claim data; and
display the overall home score.

17. The computer device of claim 16, wherein the one or more processors are further configured to:
present one or more insights to a user corresponding to the subject property; and
if an indication received from the user indicates that at least one insight of the one or more insights has been completed, update the overall home score for the subject property.

18. The computer device of claim 17, wherein the one or more insights include:
replacing a smoke detector battery;
installing a support beam;
replacing at least one pipe;
replacing an air filter; and/or
installing a water sensor.

19. A computer system for improved determination and display of a home score based upon insurance claim data, the computer system comprising:
one or more processors; and
one or more non-transitory memories, the one or more non-transitory memories having stored thereon computer-executable instructions that, when executed by the one or more processors, cause the one or more processors to:
generate an overall home score for a subject property;
receive insurance claim data for an insurance claim corresponding to the subject property, wherein the insurance claim data includes (i) a monetary amount of the insurance claim, and/or (ii) a category of the insurance claim;
modify the overall home score based upon the insurance claim data; and
display the overall home score.

20. The computer system of claim 19, the one or more non-transitory memories having stored thereon computer-executable instructions that, when executed by the one or more processors, cause the one or more processors to:
present one or more insights to a user corresponding to the subject property;
if an indication received from the user indicates that at least one insight of the one or more insights has been completed, request, from the user, imagery data associated with the at least one insight;
receive the imagery data from the user;
verify that the at least one insight has been completed based upon the imagery data; and
in response to the verification, update the overall home score for the subject property.
